(19) United States
(12) Patent Application Publication
(10) Pub. No.: US 2011/0248007 A1
(43) Pub. Date: Oct. 13, 2011

(54) ARC WELDING METHOD AND ARC WELDING APPARATUS

(75) Inventors: Hiroaki TAKEDA, Toyota-shi (JP); Keigo MORIGUCHI, Takahama-shi (JP); Shigeisa NISHIO, Anjo-shi (JP)

(73) Assignee: DENSO CORPORATION, Kariya-city (JP)

(21) Appl. No.: 13/081,789

(22) Filed: Apr. 7, 2011

(30) Foreign Application Priority Data
Apr. 7, 2010 (JP) 2010-088500

(51) Int. Cl. B23K 9/10

(52) U.S. Cl. 219/130.51

(57) ABSTRACT

A base metal composed of a plurality of metallic materials having an oxygen content of 10 ppm is first preheated partly or overall. Then AC (alternating current) current is made to pass through the preheated base metal and an electrode so as to generate an arc for welding the metallic materials. The waveform of the current is changed with time between a peak current value and a base current value excluding a current of zero value only in one of plus and minus polarity sides of the current. A current ratio defined by dividing a current amplitude between the peak and base current values by a current average of the alternating current is a range of 0.5 to 2.0. The alternating current has a frequency of 500 Hz or higher.

### CROSS-REFERENCE TO RELATED APPLICATION

This application is based on and claims the benefit of priority from earlier Japanese Patent Application No. 2010-088500 filed Apr. 7, 2010, the description of which is incorporated herein by reference.

### BACKGROUND OF THE INVENTION

1. Technical Field of the Invention

The present invention relates to an arc welding method in which an arc is generated between a base metal composed of metallic materials and an electrode to weld the metallic materials with each other, and to an arc welding apparatus which is capable of performing such welding work.

2. Related Art

Arc welding methods have been known. For example, JP-A-2001-054263 discloses a technique of arc welding method using TIG (tungsten inert gas) welding in which an arc is generated from a tungsten rod having a very high melting point toward a base metal to melt the base metal with the heat.

Also, JP-B-3948767, for example, discloses a technique of controlling the current waveform or voltage of high-frequency AC power. This technique is used for raising the stability of the arc generated by TIG welding performed for thin plates or thin-wall pipes made of metallic materials of low melting point (e.g., copper, aluminum, zinc, magnesium or an alloy of these materials).

Further, JP-A-2001-018067, for example, discloses a technique of performing TIG welding using a frequency and peak current of a predetermined range. Specifically, in this technique, an arc length (Da) is set based on a peak current (Ip) of pulses so as to fall within a range as expressed by a relation 0.5≦Da≦(Ip−120)/30 to prevent eccentricity of the arc toward a side wall of a welding groove.

Furthermore, JP-A-S49-115957, for example, discloses a technique of performing arc welding with high frequency pulses having a frequency of 1 KHz to 100 KHz. In this case, an open circuit time (t₁) for passing a principal current (I_{D}) is set by switching off a transistor, and a closed circuit time (t₂) for passing a DC base current (I_{B}) is set by switching on the transistor.

However, use of the techniques disclosed in the patent documents set forth above has created some problems in the case where metallic materials (e.g., copper) having an oxygen content of 10 ppm or more is subjected to arc welding. Specifically, in this case, a portion to be welded (hereinafter referred to as “weld portion”), in which metallic materials are melted, is burned through, or, if welding is successful, the shapes of joints will not be uniform. In such a situation, the burn-through of the weld portion will cause deterioration in welding strength, and the non-uniformity of the shapes of joints will lead to unevenness of welding strength.

It is considered that the problems set forth above are ascribed to the following causes. In a predetermined arc welding (e.g., TIG welding, MIG (metal-arc inert gas) welding and MAG (metal-arc active gas) welding), an inert gas (also called “shield gas”) flows in order to shield the base metal against the air. It is known that an addition of oxygen to the inert gas lowers the surface tension of the molten metal. When a metallic material containing oxygen is used as basic metal, the in-dwelling oxygen of the base metal emerges when the base metal is melted. This provides a state equivalent to the state where oxygen is added to an inert gas, thereby lowering the surface tension of the molten metal. In the event the surface tension of molten metal is lowered in this way, continuous addition of an arc force will cause burn-through of the weld portion, or, if the welding is successful, will make the shapes of joints non-uniform.

In the technique disclosed in JP-B-3948767, passing high-frequency AC allows alternate repetition of an event of generating an arc from the base metal toward the electrode and an event of generating arc from the electrode toward the base metal. In general, the metal to which the arc has reached is melted. Therefore, even if an electrode of a high melting point is used, the electrode as well as the base metal will be significantly melted. When the electrode is melted, the generation pathway of arc will change depending on the manner in which the electrode melts. This will cause unwanted burn-through of a portion of the base metal. Accordingly, if welding is performed successfully, the unwanted burn-through problematically tends to cause the shapes of joints to be non-uniform.

In order to solve the problem of JP-B-3948767, the technique disclosed in JP-A-S49-115957 may be applied. Specifically, as shown in FIGS. 4A to 4D, DC base current (I_{B}) is constantly passed on the side of one pole (i.e. on the side of positive pole or negative pole), while principal current (I_{P}) is passed or not passed with on/off control of a transistor. In this way, arc is generated only in the direction from the electrode toward the base metal and therefore the arc generation pathway is stabilized. However, when a metallic material containing oxygen is used as base metal, the weld portion will burn through depending on the magnitude of the set principal current (I_{P}) and the DC base current (I_{B}), or, if the welding is successful, the shapes of joints will not be uniform.

In order to weld metallic materials in base metal, an arc is required to be generated. Meanwhile, as the arc is generated for a longer time toward the same one weld portion, the weld portion is more likely to burn through, or, if the welding is successful, the shapes of joints tend to be non-uniform (irregular).

### SUMMARY OF THE INVENTION

The present invention has been made in light of the problems set forth above and has as its object to provide an arc welding method and an arc welding apparatus, which are able to suppress generation of arc as much as possible when a metallic material containing oxygen is used as base metal, prevent burn-through of a weld portion, and make the shapes of joints at the weld portions more uniform than in the conventional art.

In order to achieve the object, as one aspect, the present invention provides a method of welding a plurality of metallic materials with each other, comprising steps of: preheating partly or overall a base metal which is composed of a plurality of metallic materials having an oxygen content of 10 ppm; and first controlling a waveform of alternating current made to pass through the base metal preheated in the preheating step and an electrode so as to generate an arc for the welding, the waveform of the current being changed with time between a peak current value and a base current value excluding a current of zero value only in one of plus and minus polarity sides of the current, a current ratio defined by dividing a current amplitude between the peak and base current values by a current average of the alternating current being a range of 0.5 to 2.0, the alternating current having a frequency of 500 Hz or higher.

With this configuration, since the base metals are entirely or partially preheated by performing the preheating step before being welded, the time frame for generating an arc can be shortened, which arc is required for melting the base metal. Also, since the current is changed only on the side of one pole, the arc is generated only in one direction and thus the generation pathway of the arc is stabilized. Further, the current ratio (=current amplitude/current average) has been set so as to fall within a range of from 0.5 to 2.0 and the frequency has been set to 500 Hz or more to thereby vary the arc force applied to the weld portion. The molten metal pushed aside by the arc force is restored when the arc force is weakened. Thus, the weld portion is prevented from being burned through, whereby the shapes of the weld portions are more uniformed than in the conventional art.

In contrast, if the current ratio is smaller than 0.5, the arc force will be so insufficient that the metallic materials cannot be appropriately melted, and therefore welding strength will be lowered. On the other hand, if the current ratio is larger than 2.0, the arc force will be so large that the weld portion is likely to be burned through. If the frequency is lower than 500 Hz, the shapes of joints of the weld portions are unlikely to be uniform.

It should be appreciated that the method of preheating the base metal at the preheating step is optional. For example, the method includes a method in which the arc is generated with a temperature range up to the melting point of the metallic materials as the base metal, or a method in which the base metal is heated using a heater. When the base metal is partially preheated, the preheating is performed for the portion targeted for welding (e.g. the joint) (hereinafter referred to as “welding target”). The metallic materials may be optionally chosen if only the metallic materials have an oxygen content of 10 ppm or more. For example, such metallic materials include those which have a low melting point (e.g., copper, aluminum, zinc, magnesium, or alloys of these metals).

It is preferred that the current ratio is preferably a range of 0.5 to 1.5 and the alternating current has a frequency of 1000 Hz or higher.

With this configuration, the arc force is suppressed to a lower level and higher frequency is used than with the waveform controlling step based on the firstly mentioned numerical range. Thus, burn-through of the weld portion is more reliably prevented and thus the shapes of joints of the weld portions are more uniform.

It is also preferred that the method further comprises a step of second controlling changes in a magnetic field around the electrode by the arc as time advances in welding the metallic materials, the second controlling step being active in parallel with the first controlling step.

With this configuration, as the magnetic field generated in the vicinity of the electrode is changed, generation pathway of arc is also changed. Thus, the molten metal pushed aside by the arc force is restored because the arc force is weakened with the change of the generation pathway. Accordingly, the weld portion is prevented from being burned through, and thus the shapes of the weld portions are more uniform than in the conventional art.

Preferably, the first controlling step is adapted to control the current so as to repeat alternately a welding period for generating the arc and a non-welding period for not generating the arc.

The “welding period” refers to a time frame (period) when the current is changed between the peak current and the base current to intermittently generate the arc. The “non-welding period” refers to a time frame (period) when no arc is generated with the current being rendered to be the base current or zero.

With this configuration, the weld portion of the metallic materials is melted in the welding period, while the molten metal is prevented from being burned through being cooled in the non-welding period. In the initial welding periods, the arc is generated with a temperature range up to the melting point of the metallic materials as the base metal, whereby the preheating step may be realized.

By way of example, the first controlling step may be adapted to change the current such that at least one of the current ratio and the frequency is gradually changed with time.

Generally, the amount of molten metal is increased or decreased with the progress of welding. With this configuration, the current ratio and the frequency are gradually changed so that the amount of molten metal is controlled to be a target amount. Thus, the weld portions are prevented from being burned through and the shapes of joints of the weld portions are uniformed.

Further, the first controlling step may be adapted to change the current in conditions where the electrode is assigned to the plus polarity, the base material is assigned to the minus polarity, and the current is changed in only the minus polarity side thereof.

With this configuration, the arc is generated from the electrode toward the base metal. Therefore, consumption of the electrode is suppressed to a low level and the running cost is also suppressed to a low level.

For example, the welding of the plurality of metallic materials is either TIG (tungsten inert gas) welding or plasma arc welding.

With this configuration, the electrode material will be barely melted because a material having a very high melting point (e.g., tungsten rod) is used for the electrode. Thus, the generation pathway of arc is stabilized, leading to reliably preventing burn-through of the weld portions and thus to more reliably uniforming the shapes of the weld portions.

As another aspect, the present invention provides a method of welding a plurality of metallic materials with each other, comprising steps of: preheating partly or overall a base metal which is composed of a plurality of metallic materials having an oxygen content of 10 ppm; and first controlling a waveform of alternating current made to pass through the preheated base metal preheated and an electrode so as to generate an arc for the welding, the waveform of the current being changed with time between a peak current value and a base current value excluding a current of zero value only in one of plus and minus polarity sides of the current; and second controlling changes in a magnetic field around the electrode by the arc as time advances in welding the metallic materials, the second controlling step being active in parallel with the first controlling step.

According to this aspect, the preheating step is performed before welding to entirely or partially preheat the base metal. Therefore, the time frame for generating arc can be shortened, which arc is required for melting the base metal. Also, at the waveform controlling step, waveform is changed between the peak current and the base current. Thus, arc is generated only in one direction to thereby stabilize the generation pathway of arc. Further, at the field controlling step, the generation pathway of arc is changed with the change of the magnetic field. Therefore, the molten metal pushed aside by the arc force is restored because the arc force is weakened with the change of the generation pathway. Accordingly, each weld portion is prevented from being burned through and the shapes of joints of the weld portions can be more uniform than in the conventional art.

As another aspect of the present invention, there is provided an apparatus for welding a plurality of metallic materials with each other, comprising: preheating means for preheating partly or overall a base metal which is composed of a plurality of metallic materials having an oxygen content of 10 ppm; and first controlling means for controlling a so waveform of alternating current made to pass through the preheated base metal and an electrode so as to generate an arc for the welding, the waveform of the current being changed with time between a peak current value and a base current value excluding a current of zero value only in one of plus and minus polarity sides of the current. Preferably, a current ratio defined by dividing a current amplitude between the peak and base current values by a current average of the alternating current is a range of 0.5 to 2.0, and the alternating current has a frequency of 500 Hz or higher.

With this configuration, the base metal is entirely or partially preheated by the preheating means before being welded. Therefore, the time frame for generating arc can be shortened, which arc is required for melting the base metal. In the waveform controller, waveform is changed between the peak current and the base current. Thus, arc is generated only in one direction to thereby stabilize the generation pathway of arc.

Further, arc is generated by setting the current ratio to a range of from 0.5 to 2.0 and the frequency to 500 Hz or more. Thus, the arc force applied to the weld portion is varied. Since the molten metal pushed aside by the arc force is restored when the arc force is weakened, the weld portions are each prevented from being burned through and thus the shapes of joints of the weld portions are more uniformed than in the conventional art.

In the basic configuration of the apparatus, the apparatus comprises second controlling means for controlling changes in a magnetic field around the electrode by the arc as time advances in welding the metallic materials, the second controlling means being operated in parallel with the first controlling means.

According to this aspect, the base metal is entirely or partially preheated by the preheating means. Therefore, the time frame for generating arc can be shortened, which arc is required for melting the base metal. Also, the waveform controller changes waveform between the peak current and the base current. Therefore, arc is generated only in one direction to thereby stabilize the generation pathway of arc. Further, the field controller changes the generation pathway of arc with the change of the magnetic field. Therefore, the molten metal pushed aside by the arc force is restored because the arc force is weakened with the change of the generation pathway. Accordingly, each weld portion is prevented from being burned through and the shapes of joints of the weld portions can be more uniform than in the conventional art.

### BRIEF DESCRIPTION OF THE DRAWINGS

In the accompanying drawings:

FIG. 1 is a schematic diagram illustrating a configurational example of an arc welding apparatus of the present invention;

FIG. 2 is a diagram illustrating an example of controlling current waveform (pulse waveform);

FIGS. 3A to 3C are diagrams illustrating examples of various current waveforms;

FIGS. 4A to 4D each illustrate arc conditions and shapes of joints when frequency is changed;

FIG. 5 illustrates arc conditions and the shape of joint when a conventional technique is applied;

FIG. 6 is a graphic diagram illustrating an example of a relationship between frequency and welding strength ratio;

FIG. 7 is a graphic diagram illustrating an example of a relationship between current ratio and welding strength ratio; and

FIGS. 8A and 8B are diagrams each illustrating an example of control for gradually changing current waveform.

### DETAILED DESCRIPTION OF THE PREFERRED EMBODIMENTS

With reference to the accompanying drawings, hereinafter will be described an embodiment of the present invention. It should be appreciated that, throughout the specification, the term “connect” or “connection” refers to “electrically connected” or “electrical connection” unless specifically defined. Also, the terms which indicate directions, such as top, down, left and right, which are given in the specification, refer to the directions with reference to the drawings as viewed.

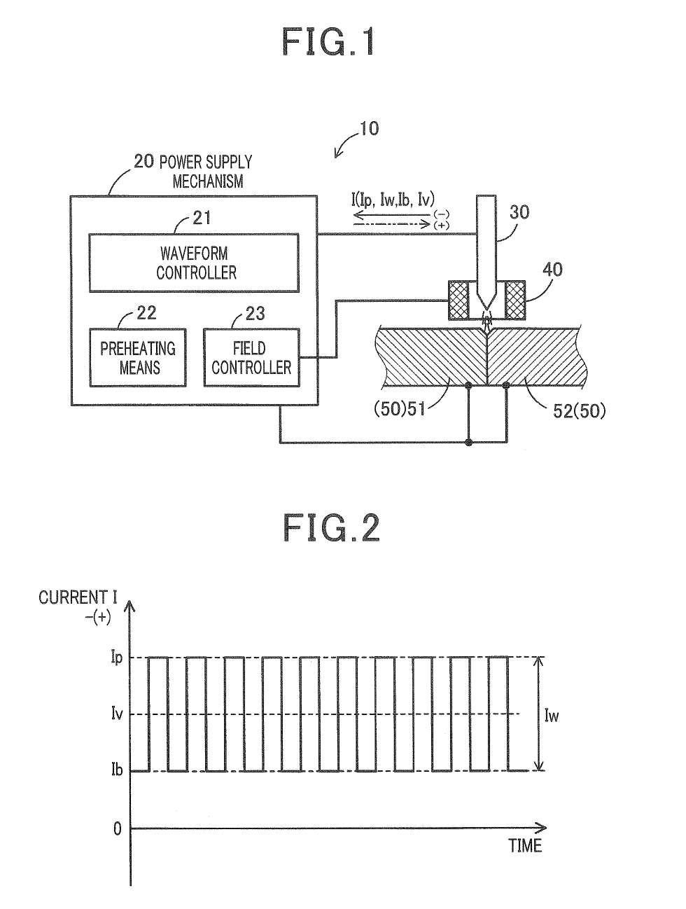

With reference to FIGS. 1 to 7, an arc welding apparatus according to an embodiment of the present invention will now be described.

FIG. 1 is a schematic diagram illustrating a configurational example of an arc welding apparatus 10 according to the embodiment. In the present embodiment, the arc welding apparatus 10 is provided as an apparatus for a TIG (tungsten inert gas) welding apparatus or a plasma arc welding apparatus. The arc welding apparatus 10 shown in FIG. 1 includes base metal 50 (i.e. first base metal 51 and second base metal 52), an electrode 30 (torch), a power supply mechanism 20 and a field generator 40. The arc welding apparatus 10 is configured to generate an arc between the base metal 50 and the electrode 30 to weld metallic materials.

Any metallic material having oxygen content of 10 ppm or more is applicable as the base metal 50. In order to facilitate welding with an arc, it is desirable to use those metallic materials (e.g., copper, aluminum, zinc, magnesium or alloys of these metals) which have a low melting point. Any metallic material is usable as the electrode 30, which potentially generates an arc between the electrode 30 and the base metal 50. However, the electrode 30 may desirably be a non-consumable material which is not consumed (or only slightly consumed) when the arc is generated. Such non-consumable material here includes tungsten (including mixtures of tungsten with thorium, cerium, lanthanum or zirconium).

The power supply mechanism 20 is configured to receive electrical power which is supplied from a power source (e.g., a commercially available power supply or battery), not shown, so that AC (alternating current) current can be outputted for the generation of arc between the base metal 50 and the electrode 30. To realize the present invention, the power supply mechanism 20 includes a waveform controller 21, preheating means 22 and a field controller 23.

As a matter of course, the power supply mechanism 20 and the electrode 30 are connected via an electrical conductor cable, for example. Similarly, the power supply mechanism 20 and the base metal 50 (first base metal 51 and second base metal 52) are connected via an electrical conductor cable, for example. When the electrode 30 serves as a negative pole and the base metal 50 serves as a positive pole, the current I flows counterclockwise as indicated by the solid line arrow in FIG. 1. Contrarily, when the electrode 30 serves as a positive pole and the base metal 50 serves as a negative pole, the current I flows clockwise as indicated by the dash-dot-dot line arrow in FIG. 1.

The configuration and the like of the waveform controller 21 will be described later. The preheating means 22 has a function of entirely or partially preheating the base metal 50.

The preheating means 22 may be optionally configured if only the base metal 50 is entirely or partially preheated. For example, the preheating means 22 may be configured such that arc is generated with a temperature range up to the melting point of the metallic materials as the base metal 50. This configuration is suitable for partially preheating the base metal 50. Desirably, this configuration may be used, in particular, for preheating a welding target.

The preheating means 22 may also be configured such that the base metal 50 is preheated using a heating element, such as a heater. This configuration is suitable for entirely preheating the base metal 50. Preheating temperature depends on the materials of the base metal 50. For example, preheating temperature in the case of copper is 100° C. to 300° C.

The field controller 23 has a function of controlling magnetic field which is generated in the vicinity of the electrode 30 by the field generator 40. As the magnetic field is changed, the generation pathway of the arc is changed. The field generator 40 may be optionally configured if only the intensity and the direction, for example, of the magnetic field are controllable. For example, the field generator 40 may be configured by an electromagnet or a magnet coil.

The waveform controller 21 has a function of controlling the waveform of the current I for generating arc between the base metal 50 and the electrode 30. Referring to FIG. 2, hereinafter is described an example of controlling waveform (pulse waveform as one example).

FIG. 2 is a diagram illustrating an example of controlling a current waveform. The current waveform shown in FIG. 2 changes between a peak current Ip and a base current Ib not including zero, only on the side of one pole (i.e. on the side of positive pole or negative pole). In other words, the current I that is the base current Ib (DC component) is constantly permitted to flow. The base current Ib is superimposed by a pulse wave component (waveform component) that changes with current amplitude Iw. For example, when the electrode 30 is a negative pole and the base metal 50 is a positive pole, the current I changes between the peak current Ip and the base current Ib on the side of the negative pole. The current amplitude Iw indicates amplitude between the peak current Ip and the base current Ib.

The waveform controller 21 outputs the current I with a current ratio Ir, which is calculated from a formula Ir=Iw/Iv (where Iv is current average). Specifically, the waveform controller 21 outputs the current with the current ratio Ir ranging from 0.5 to 2.0 and with a frequency being equal to or more than 500 Hz. More preferably, the current I is outputted with the current ratio Ir ranging from 0.5 to 1.5 and with the frequency being equal to or more than 1000 Hz.

The current average Iv indicates the average of the changing current I. The upper limit of the frequency can be optionally set as far as the arc is not continuously generated. If the frequency is extremely high and hence the frequency cycle is shortened, arc will come to be continuously generated. For this reason, the upper limit of the frequency should resultantly fall within a range of from about 100 KHz to 1 MHz in order that the arc is intermittently generated.

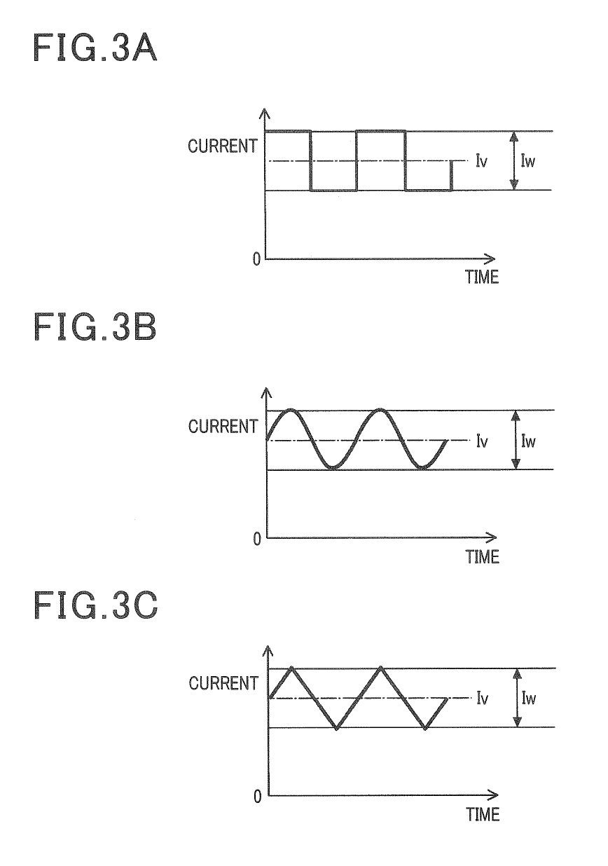

FIGS. 3A to 3C are diagrams illustrating examples of various current waveforms. The current waveform superimposed on the base current Ib of the current I by the waveform controller 21 is not limited to the pulse wave (rectangular wave) shown in FIG. 3A. Specifically, the current waveform may be a sinewave as shown in FIG. 3B or a rectangular wave as shown in FIG. 3C or other current waveforms, such as a sawtooth wave. Regarding these current waveforms, a current waveform of only one type may be superimposed on the base current Ib or two or more types of current waveforms in combination may be superimposed. Also, the superimposed waveforms may be switched depending on the materials of the base metal 50 to be welded or the conditions (temperature, humidity, etc.) at the time of welding. For example, a pulse wave may be superimposed for a time frame (period) and a sinewave may be superimposed for another time frame (period).

Further, the waveform controller 21 effects control so as to repeat the alternation of a welding period for generating arc and a non-welding period for not generating arc. For example, this control is applied to a mode where a plurality of welding targets are arranged being spaced apart from each other along a curved (annular in particular) or linear line and welding is performed from target to target by, for example, rotating or moving the targets.

Normally, the current I is passed for generation of arc and welding, when the base metal 50 and the electrode 30 are at positions where the relative distance therebetween is the shortest (hereinafter, these positions are referred to as “welding positions”). Specifically, the time frame when the base metal 50 and the electrode 30 are at the welding positions corresponds to the “welding period”. Also, the time frame when the base metal 50 and the electrode 30 are at positions other than the welding positions corresponds to the “non-welding period”.

Depending on the way of rotation, movement or the like, the same welding targets may be at the welding positions for a plurality of times (preset number of times, which is twice or more). In this case, welding is performed for the plurality of times. Also, in this case, the base metal 50 as the metallic materials can be preheated in the initial welding periods (e.g., covering the first time alone or up to the second time) by generating an arc with a temperature range up to the melting point of the metallic materials.

Hereinafter is briefly described an arc welding method in which arc is generated between the base metal 50 (specifically, the first and second base metals 51 and 52 shown in FIG. 1) and the electrode 30 to weld the metallic materials using the arc welding apparatus 10. The arc welding method includes the following steps.

(1) Preheating Step

At the preheating step performed before welding, the base metal 50 is entirely or partially preheated. When the base metal 50 is partially preheated, the preheating is performed for the welding target.

(2) Waveform Controlling Step

Desirably, the waveform controlling step is performed in an earlier time period following the preheating in order to shorten the time frame (period) for generating arc, making full use of the preheating. The welding target of the metallic materials (base metal 50) is melted and welded by passing the current I shown in FIGS. 2 and 3A to 3C and generating arc between the base metal 50 and the electrode 30. In the case where the same welding target is positioned at the welding position for a plurality of times, welding is performed by switching the intensity of the current I between preheating and welding.

(3) Field Controlling Step

The field controlling step is performed in parallel with the waveform controlling step. At the field controlling step, the magnetic field generated by the field generator 40 in the vicinity of the electrode 30 is changed with the progress of the welding. The intensity and direction of the magnetic field are of levels that allow change of the pathway of arc generated between the base metal 50 and the electrode 30. Conversely, appropriate control of the magnetic field stabilizes the pathway of arc.

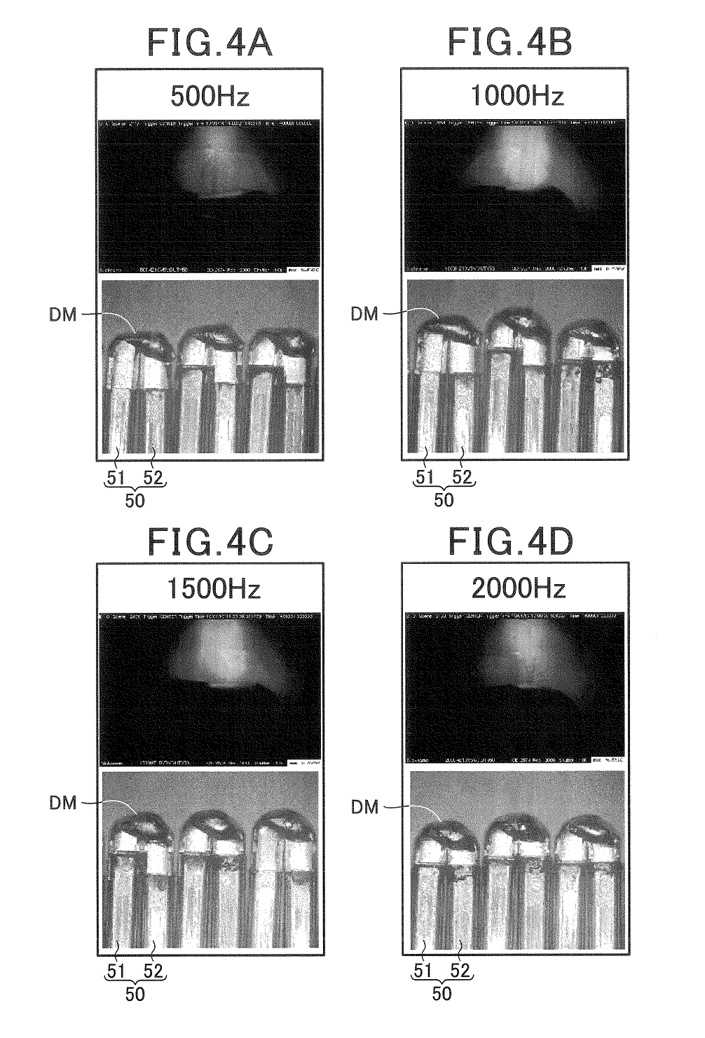

FIGS. 4A to 4D each illustrate arc conditions and shapes of joints when frequency is changed. Specifically, FIGS. 4A to 4D show the experimental results of the arc welding performed by the arc welding apparatus 10 for the base metal 50 (i.e. the first and second base metals 51 and 52 shown in FIG. 1) that is copper having an oxygen content of 10 ppm, by setting four frequencies having the pulse wave component shown in FIG. 2.

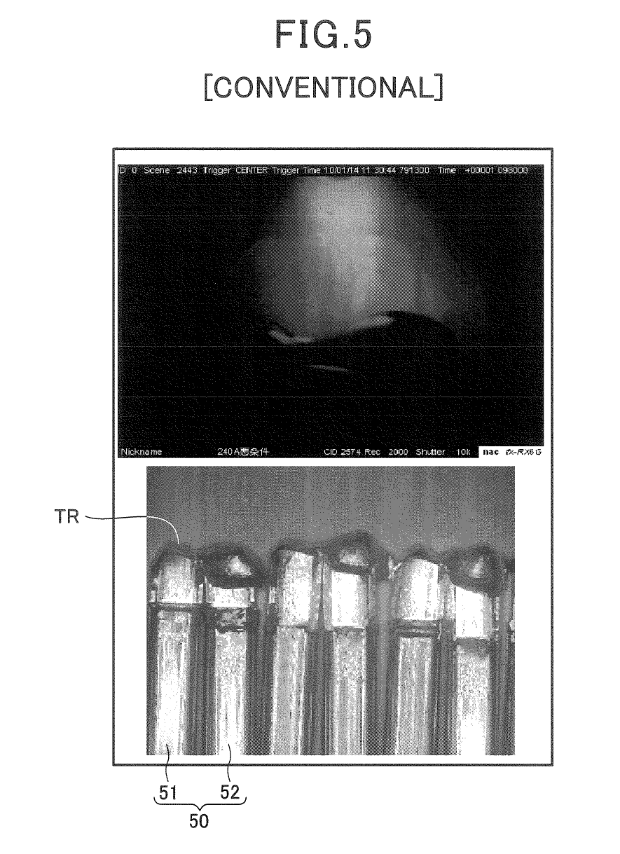

FIGS. 4A to 4C show the cases where the frequency is set to 500 Hz, 1000 Hz, 1500 Hz and 2000 Hz, respectively. For comparison, FIG. 5 shows arc conditions and shapes of joints when welding is performed using a conventional technique. In each of these figures, the arc conditions are shown on the top and the results of welding are shown at the bottom. The bottom of each figure shows the results of welding in which six samples of the base metal 50 are arranged in a row, being combined into three sets (left, middle and right) of the first and second base metals 51 and 52.

In the results shown in FIGS. 4A to 4D, the joint at the weld portion has a dome shape for each of all the three sets. As can be seen, the weld portions of the three sets in each figure have substantially the same dome shape DM as shown in each of FIGS. 4A to 4D. Substantially the same shape of joint means that the welding strength is substantially even. In the conventional art, on the other hand, the joint at the weld portion has a different rectangular shape TR between the three sets as shown at the bottom of FIG. 5. Therefore, the welding strength is uneven in FIG. 5.

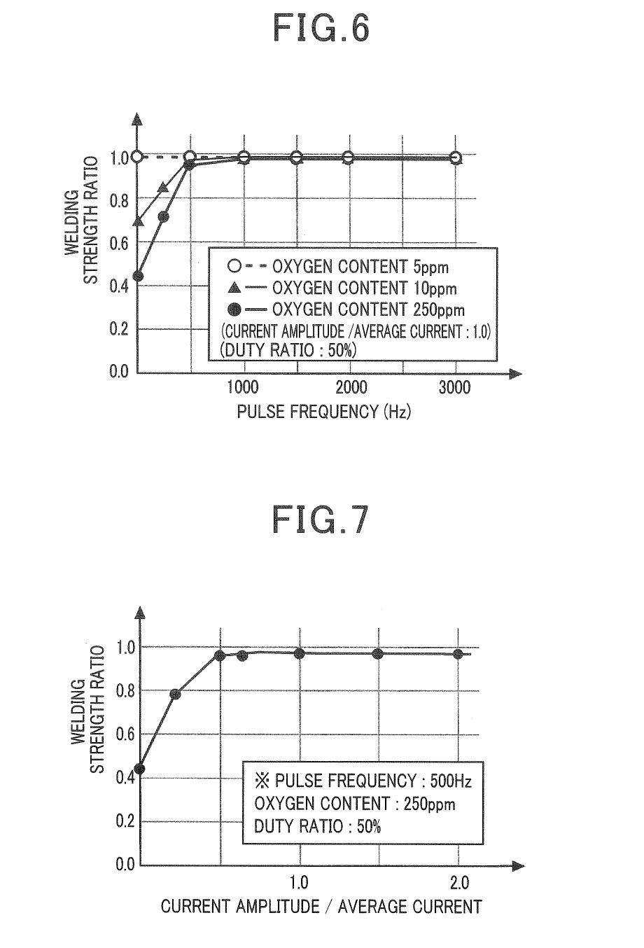

FIG. 6 is a graphic diagram illustrating an example of a relationship between frequency and welding strength ratio. Specifically, FIG. 6 shows the change of strength applied to a weld portion in the case where the oxygen content and the frequency of pulse wave component are changed. FIG. 6 is a graphic diagram in which the vertical axis indicates a welding strength ratio Sr and the horizontal axis indicates the frequency of pulse wave component. The welding strength ratio Sr is a ratio of a welded strength Sb to a reference strength Sa and expressed by a formula Sr=Sb/Sa. The reference strength Sa refers to a strength of a weld portion of the base metal 50 as pure copper (with oxygen content of 0 ppm), the portion having been welded with a current ratio Ir as being 1.0. The welded strength Sb refers to a strength at a weld portion of the base metal 50 as copper, the portion having been welded by changing the oxygen content of the copper and the frequency of the pulse wave component.

Specifically, FIG. 6 shows the welding strength ratio Sr at the time when the frequency of the pulse wave component has been changed for copper with an oxygen content of 5 ppm (indicated by “O”), copper with an oxygen content of 10 ppm (indicated by “Δ”) and copper with an oxygen content of 250 ppm (indicated by “∘”). Welding has been performed by setting the duty ratio of the pulse wave component to 50% and setting the frequency thereof to 0 Hz, 500 Hz, 1000 Hz, 1500 Hz, 2000 Hz and 3000 Hz.

According to the results shown in FIG. 6, when the frequency of the pulse wave component is set to 500 Hz or more, the welding strength ratio Sr becomes a value approximate to 1.0, irrespective of the increase of the oxygen content of the copper used for the base metal 50. Similar results are obtained for the metallic materials other than copper. Accordingly, when the arc welding is performed with the frequency of the pulse wave component being set to 500 Hz or more, the strength applied to a weld portion will be equivalent to the strength resulting from the welding using pure materials (materials having an oxygen content of 0 ppm), irrespective of the level of the oxygen content.

In addition, the experimental results illustrated in FIG. 6 shows that the arc welding is preferably performed with the frequency of the pulse wave component set to 1000 Hz or more.

FIG. 7 is a graphic diagram illustrating an example of a relationship between current ratio and welding strength ratio. Specifically, FIG. 7 shows the change of strength applied to a weld portion in the case where the current ratio Ir of the current I is changed. In FIG. 7, the vertical axis indicates welding strength ratio and the horizontal axis indicates the current ratio Ir (i.e. Iw/Iv, where Iw is current amplitude and iv is current average). The definition of the welding strength ratio Sr is the same as the case shown in FIG. 6. The duty ratio of the pulse wave component has been set to 50% and the frequency thereof has been set to 500 Hz. Welding has been performed with the current ratio Ir of the current I being set to 0, 0.2, 0.5, 0.6, 1.0, 1.5 and 2.0.

According to the results shown in FIG. 7, the strength associated with weld portion will be equivalent to the strength in the case of using pure materials, if the current ratio Ir of the current I is 0.5 or more or falls within a range up to at least 2.0. Although not shown, the same results have been obtained in the case where the oxygen content of copper used for the base metal 50 is changed in a manner shown in FIG. 6, with the duty ratio and the frequency of the pulse wave component being set to values other than those shown in FIG. 7.

Additionally, the experimental results illustrated in FIG. 7 shows that the arc welding is preferably performed with the current ratio Ir of 0.5 to 1.5.

According to the embodiment described above, the advantages as set forth below are obtained.

In the configuration of the arc welding method described above, metallic materials having an oxygen content of 10 ppm or more have been used as the base metal 50 and the base metal 50 has been entirely or partially preheated using the preheating means 22 (or preheating step). Then, the waveform of the current I has been changed between the peak current Ip and the base current Ib without including zero, on the side of one pole (i.e. on the side of the positive pole or negative pole). Further, the current ratio Ir has been set so as to fall within a range of from 0.5 to 2.0 and the frequency has been set to 500 Hz or more to thereby generate arc (waveform control; see FIGS. 1 to 7).

With this configuration, since the base metal 50 is preheated before being welded, the time frame for generating the arc can be shortened, which arc is required for melting the base metal 50. Also, since the current I is changed only on the side of one pole, arc is generated only in one direction and thus the generation pathway of arc is stabilized. Further, the current ratio Ir has been set so as to fall within a range of from 0.5 to 2.0 and the frequency has been set to 500 Hz or more to thereby vary the arc force applied to the weld portion. The molten metal pushed aside by the arc force is restored when the arc force is weakened. Thus, the weld portion is prevented from being burned through, whereby the shapes of the weld portions are more uniformed than in the conventional art.

At the waveform controlling step (or means), it has been so configured that the current ratio Ir is set so as to fall within the range of from 0.5 to 1.5 and the frequency is set to 1000 Hz or more to thereby generate the arc (see FIGS. 1 to 7).

With this configuration, arc force is suppressed to a low level while the frequency is raised. Thus, burn-through of each weld portion is reliably prevented to thereby uniform the shapes of weld portions.

The field controller 23 has been configured to progress welding and change the magnetic field generated in the vicinity of the electrode 30 (waveform control; see FIG. 1).

With this configuration, as the magnetic field generated in the vicinity of the electrode 30 is changed, generation pathway of arc is also changed. Thus, the molten metal pushed aside by the arc force is restored because the arc force is weakened with the change of the generation pathway. Accordingly, the weld portion is prevented from being burned through, and thus the shapes of the weld portions are more uniformed than in the conventional art.

It has been so configured that the welding period and the non-welding period are alternately repeated.

With this configuration, the weld portions of the metallic materials are melted in the welding period, while the molten metal is prevented from being burned through by being cooled in the non-welding period. In the initial welding periods (only the first welding period or up to the second welding period, etc.), arc is generated with a temperature range up to the melting point of the metallic materials as the base metal 50, whereby the base metal 50 is preheated.

At the waveform controlling step, it has been so configured that the electrode 30 is used as a negative pole and the base metal 50 is used as a positive pole and that the current I is changed between the peak current Ip and the base current Ib on the side of the negative pole (see FIGS. 1 and 2).

With this configuration, arc is generated from the electrode 30 toward the base metal 50. Therefore, consumption of the electrode 30 is suppressed to a low level and the running cost is also suppressed to a low level. It is desirable that a non-consumable material be used for the electrode 30, which material is not consumed (or only slightly consumed) when arc is generated. For example, the non-consumable material includes tungsten (including the tungsten which includes thorium, cerium, lanthanum or zirconium).

It has been so configured that either one of TIG welding and plasma arc welding is performed (see FIG. 1).

With this configuration, the electrode 30 per se will be barely melted because a non-consumable material is used for the electrode 30. Thus, the generation pathway of arc is stabilized, leading to reliably preventing burn-through of the weld portions and thus to more reliably uniforming the shapes of the weld portions.

An embodiment of the present invention has been described so far, but the present invention is not limited to this embodiment. In other words, the present invention may be implemented in various embodiments within the scope not departing from the spirit of the present invention. For example, the present invention may be implemented in the following various modifications.

### Modifications

In the modifications set forth below, the components identical with or similar to those in the above embodiment are given the same reference numerals for the sake of omitting explanation.

In the embodiment described above, the waveform controller 21 (or waveform controlling step) has been configured so that the current ratio Ir falls within a range of from 0.5 to 2.0 with the peak current Ip being set to a constant level (see FIG. 2). Alternative to the above embodiment, the peak current Ip may be gradually changed depending on the conditions of the weld portion which changes with the progress of welding.

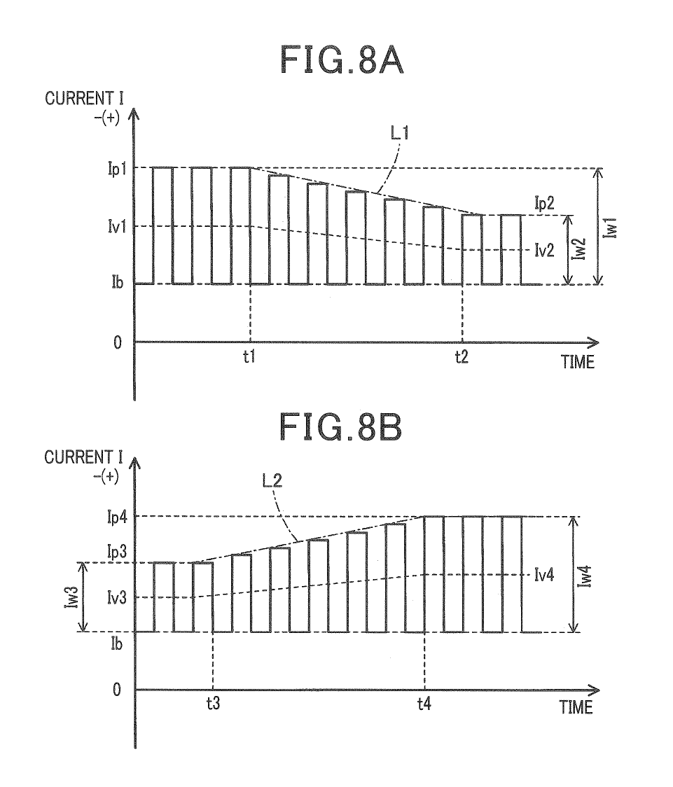

FIGS. 8A and 8B are diagrams each illustrating an example of control for gradually changing current waveform. Specifically, FIG. 8A shows an example of gradually decreasing change and FIG. 8B shows an example of gradually increasing change. In FIG. 8A, a peak current Ip1 continues until time t1. From the time t1 onward up to time t2, the peak current Ip is gradually decreased along a gradual-decrease line L1. From the time t2 onward, control is effected so that a peak current Ip2 continues. In FIG. 8B, a peak current Ip3 continues until time t3. From the time t3 onward up to time t4, the peak current Ip is gradually increased along a gradual-increase line L2. From time t4 onward, control is effected so that a peak current Ip4 continues. Since the current ratio Ir here is maintained at a constant level, the current average Iv changes with the change of the peak current Ip. The inclination (gradual-decrease factor or gradual-increase factor) of the gradual-decrease line L1 and the gradual-increase line L2 depends on the materials of the base metal 50. Thus, these lines L1 and L2 may not necessarily be straight lines as shown in FIGS. 8A and 8B but may be curved lines. Only one of the gradual-decrease change and the gradual-increase change may be performed, or these changes may be alternated with the progress of welding.

Alternative to the modification in which the peak current Ip is gradually changed, other modifications are also available, such as a modification in which the base current Ib is changed, a modification in which pulse width is changed when a pulse wave component is superimposed on the current I, and a modification in which the frequency of a waveform component is changed. These modifications are not limited to the case where the current ratio Ir is maintained at a constant level. These modifications similarly work when the current ratio Ir is changed within a range of from 0.5 to 2.0 without maintaining the current Ir at a constant level. In any of the modifications, advantages and effects similar to those in changing the current Ip as described above can be obtained.

In the modifications mentioned above, the gradual-decrease factor and the gradual-increase factor, as well as the timing of the times t1, t3 and the timing of the times t2 and t4 are set, depending such as on the materials of the base metal 50 and the electrode 30 and the conditions of welding. As a matter of fact, these factors and timing may desirably be set referring to the results of experiments or field tests performed in advance. For complete automation, a weld portion may be imaged using an image pickup device, the picked up image may be processed to obtain the shape of joint of the weld portion, and then the peak current Ip (or the base current Ib or pulse width) may be changed so that the present shape of joint will be similar to a target shape of joint.

The waveform controller 21 has been so configured that either one of or both of the current ratio Ir and the frequency is gradually changed with the progress of welding (see FIGS. 5A and 8B).

With this configuration, the gradual change of the current ratio Ir or the frequency can control the amount of molten metal to be a target amount, and can also prevent burn-through and can uniform the shapes of the weld portions.

In the above embodiment, it has been so configured that either one of TIG (tungsten inert gas) welding and plasma arc welding is performed (see FIG. 1). As an alternative, the present invention may be applied to other welding methods, such as shielded metal arc welding, semi-automatic arc welding, gas shielded arc welding, MIG (metal inert gas) welding, MAG (metal active gas) welding, CO₂ gas shielded arc welding, submerged arc welding and tandem arc welding. In the case of applying the present invention to other welding methods as well, the advantages and effects similar to those of the embodiment described above can be obtained, i.e. suppressing generation of arc as much as possible, preventing burn-through of the weld portions, and making the shapes of joints of the weld portions more uniformed than in the conventional art.

In the embodiment described above, the present invention has been applied to the case where two samples of the base metal 50 (i.e. first and second base metals 51 and 52) are welded disposed being opposed to each other (see FIG. 1). Alternative to this, the present invention may also be applied to the case where three or more materials of the base metal 50 are welded at one spot, or to the case where two or more materials of the base metal 50 are butted together to form a predetermined shape (e.g., shape of L or T). The changes made in these cases are only the number of objects to be welded and only the mode of welding. Accordingly, in these cases as well, the advantages and effects similar to those in the above embodiment can be obtained.

The embodiment of the present invention has been described so far. However, the above embodiment may include different modes than the mode recited in the claims. The different modes of the invention are set forth below with an explanation, where necessary.

What is claimed is:

1. A method of welding a plurality of metallic materials with each other, comprising steps of:
preheating partly or overall a base metal which is composed of a plurality of metallic materials having an oxygen content of 10 ppm; and
first controlling a waveform of AC (alternating current) current made to pass through the base metal preheated in the preheating step and an electrode so as to generate an arc for the welding, the waveform of the current being changed with time between a peak current value and a base current value excluding a current of zero value only in one of plus and minus polarity sides of the current, a current ratio defined by dividing a current amplitude between the peak and base current values by a current average of the AC current being a range of 0.5 to 2.0, the AC current having a frequency of 500 Hz or higher.

2. The method of claim 1, wherein the current ratio is preferably a range of 0.5 to 1.5 and the AC current has a frequency of 1000 Hz or higher.

3. The method of claim 2, further comprises a step of second controlling changes in a magnetic field around the electrode by the arc as time advances in welding the metallic materials, the second controlling step being active in parallel with the first controlling step.

4. The method of claim 3, wherein the first controlling step is adapted to control the current so as to repeat alternately a welding period for generating the arc and a non-welding period for not generating the arc.

5. The method of claim 4, wherein the first controlling step is adapted to change the current such that at least one of the current ratio and the frequency is gradually changed with time.

6. The method of claim 5, wherein the first controlling step is adapted to change the current in conditions where the electrode is assigned to the plus polarity, the base material is assigned to the minus polarity, and the current is changed in only the minus polarity side thereof.

7. The method of claim 6, wherein the welding of the plurality of metallic materials is either TIG (tungsten inert gas) welding or plasma arc welding.

8. The method of claim 7, wherein the preheating step is adapted to preheat the base metal until the base metal is heated to a predetermined temperature assigned to the base metal, the predetermined temperature depending on types of components of the base metal.

9. The method of claim 1, further comprises a step of second controlling changes in a magnetic field around the electrode by the arc as time advances in welding the metallic materials, the second controlling step being active in parallel with the first controlling step.

10. The method of claim 1, wherein the first controlling step is adapted to control the current so as to repeat alternately a welding period for generating the arc and a non-welding period for not generating the arc.

11. The method of claim 1, wherein the first controlling step is adapted to change the current such that at least one of the current ratio and the frequency is gradually changed with time.

12. The method of claim 1, wherein the first controlling step is adapted to change the current in conditions where the electrode is assigned to the plus polarity, the base material is assigned to the minus polarity, and the current is changed in only the minus polarity side thereof.

13. The method of claim 1, wherein the welding of the plurality of metallic materials is either TIG (tungsten inert gas) welding or plasma arc welding.

14. The method of claim 1, wherein the preheating step is adapted to preheat the base metal until the base metal is heated to a predetermined temperature assigned to the base metal, the predetermined temperature depending on types of components of the base metal.

15. The method of claim 2, wherein the first controlling step is adapted to control the current so as to repeat alternately a welding period for generating the arc and a non-welding period for not generating the arc.

16. The method of claim 2, wherein the first controlling step is adapted to change the current such that at least one of the current ratio and the frequency is gradually changed with time.

17. A method of welding a plurality of metallic materials with each other, comprising steps of:
preheating partly or overall a base metal which is composed of a plurality of metallic materials having an oxygen content of 10 ppm; and
first controlling a waveform of AC (alternating current) current made to pass through the preheated base metal preheated and an electrode so as to generate an arc for the welding, the waveform of the current being changed with time between a peak current value and a base current value excluding a current of zero value only in one of plus and minus polarity sides of the current; and
second controlling changes in a magnetic field around the electrode by the arc as time advances in welding the metallic materials, the second controlling step being active in parallel with the first controlling step.

18. An apparatus for welding a plurality of metallic materials with each other, comprising:
preheating means for preheating partly or overall a base metal which is composed of a plurality of metallic materials having an oxygen content of 10 ppm; and
first controlling means for controlling a waveform of AC (alternating current) current made to pass through the preheated base metal and an electrode so as to generate an arc for the welding, the waveform of the current being changed with time between a peak current value and a base current value excluding a current of zero value only in one of plus and minus polarity sides of the current.

19. The apparatus of claim 18, wherein a current ratio defined by dividing a current amplitude between the peak and base current values by a current average of the AC current is a range of 0.5 to 2.0, and the AC current has a frequency of 500 Hz or higher.

20. The apparatus of claim 18, comprising second controlling means for controlling changes in a magnetic field around the electrode by the arc as time advances in welding the metallic materials, the second controlling means being operated in parallel with the first controlling means.
